(19) United States
(12) Patent Application Publication
(10) Pub. No.: US 2009/0229442 A1
(43) Pub. Date: Sep. 17, 2009

(54) PLECTRUM WITH ATTACHED GRASPING DEVICES

(75) Inventor: James Theodore Hollin, JR., Tyrone, GA (US)

Correspondence Address: J.T. HOLLIN, ATTORNEY AT LAW, PC, 110 HABERSHAM DRIVE, SUITE 144, FAYETTEVILLE, GA, 30214, US

(73) Assignee: Wingnotes de Guitaura, LLC (a Georgia corporation), Tyrone, GA (US)

(21) Appl. No.: 12/075,544

(22) Filed: Mar. 12, 2008

(51) Int. Cl. G10D 3/16

(52) U.S. Cl. 84/322

(57) ABSTRACT

A plectrum with an enhanced design feature, primarily consisting of an extended gripping surface, or “tab,” said tab facilitating the attachment of a variety of grasping devices to the plectrum. A musician is thereby provided a secure and comfortable method of grasping and retaining the plectrum while playing a stringed musical instrument. Both the tabbed plectrum and the grasping devices disclosed are further used in conjunction with each other to facilitate the ergonomic playing of such instruments. Additionally disclosed are methods for the efficient movement of a musician's forearm and wrist muscles while utilizing the combination of a tabbed plectrum and grasping device during the playing of a stringed musical instrument.

### CROSS-REFERENCES TO RELATED APPLICATIONS

U.S. Patent Documents

| U.S. Patent # | Date | Classification | Inventor |
|---|---|---|---|
| 557,293 | March 1896 | 251/48 | Wahl, F. |
| 1,184,561 | May 1916 | 84/322 | Napoletano, A. |
| 1,263,740 | April 1918 | 84/322 | Burdwise, A. |
| 2,776,592 | January 1957 | 84/322 | Di Preta, M. |
| 3,648,558 | March 1972 | 84/322 | Chenette, J. |
| 3,699,838 | October 1972 | 84/322 | Montgomery, E. |
| 4,270,433 | June 1981 | 84/322 | Adamec, R. |
| 4,067,255 | January 1978 | 84/322 | Camaioni, R. |
| 4,270,433 | June 1981 | 84/322 | Adamec, G. |
| 4,497,237 | February 1985 | 84/322 | Beall, M. |
| 5,837,913 | November 1998 | 84/329 | Newman, J. |
| 6,040,512 | March 2000 | 84/322 | Polley, Z. |
| 6,054,643 | April 2000 | 84/322 | Chance, A., et al. |
| 6,118,058 | September 2000 | 84/320 | Rowley, P. |
| 6,127,613 | October 2000 | 84/332 | Pittman, et al. |
| 6,346,662 | December 2002 | 84/320 | Drayth, S. |
| 6,903,256 | June 2005 | 84/322 | Pittman, et al. |

U.S. Patent Applications

| | | | |
|---|---|---|---|
| 2003004058 | March 2003 | 84/322 | Pearson-Bey, T. |

Foreign Patent Documents

| | | | |
|---|---|---|---|
| GB2347550 | June 2002 | G10D 3/16 | McErlaine, A. |
| JP200204103 | August 2002 | G10D 3/16 | Mari, T. |

### OTHER REFERENCES

“Shark Tooth” Thumbpick, designed by Greg Atkin; http://www.adirondackguitar.com/picks/shrk.htm
Abledata; picks for disabled persons or those with physical limitations; 8630 Fenton Street, Suite 930, Silver Spring, Md. 20910; http://www.abledata.com A Patient/s Guide to Arthritis of the Finger Joints; Hand University; 3010N; Circle Drive, #200, Colorado Springs, Colo. 80909
Cubital Tunnel Syndrome in Guitarists; Timothy J. Jameson, D. C., C.C.S.P.; http://.museweb.com/ag/cubital.html

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

(1) Field of the Invention

The inventive concepts presented herein generally are concerned with devices and methods for playing stringed musical instruments, especially guitars. Historically, stringed instruments such as guitars, bass guitars, banjos, mandolins and the like are played either with the fingers, or more frequently, with the assistance of a plectrum. Plectrums come in a variety of sizes, weights, densities, materials, and textures. They are usually 0.5 mm to 1.0 mm thick, but can be much thicker. Plectrums are generally constructed in the approximate shape of an isosceles triangle, with rounded base angles and a relatively elliptical apex, or “picking point.” The musician normally orients the plectrum so as to make the picking point the part of the plectrum which strikes the strings of the instrument. Occasionally a musician will orient the plectrum sidewise so as to strike the strings with one of the unilateral sides of the plectrum and thus obtain a “fatter” sound from the strings.

It is not uncommon for a musician to lose the most effective position of his or her grip on the plectrum while playing, or to drop the plectrum entirely when playing rapid or intense passages consisting of multitudes of musical notes. If the grip on the plectrum is accidentally misaligned, the musician may not be able to timely strike the string or strings which for which he or she is aiming, and as an added consequence, the timbre of the string, or the quality of its induced resonance is lessened by such a mis-strike.

(2) Description of the Related Art

Musicians and instrument makers have been, for over one hundred years, making improvements and modifications in the basic simple plectrum, to make the device more versatile or convenient to use. A very early invention in this vein was designed in 1896, and involved a holder device for mandolin picks; ref. U.S. Pat. No. 557,293. The holder was flexible enough such that, by varying pressure on the device with the thumb and forefinger, a musician was able to strike the mandolin strings very soft with low volume or with force for louder, more emphatic tones. The holder minimized the risk of dropping the pick or losing grip.

In 1916, U.S. Pat. No. 1,184,561 presented a design for a mandolin pick holder which resembled a miniature horseshoe. The device was made with a recessed chamber, sized so as to accommodate the insertion of the pick. The preferred embodiment of the device was made of rubber, which gave enhanced gripping qualities to the musician, as the gripping pressure of the fingers engaged the friction of the rubber. The pressure of the fingers also provided a firm retention force for maintaining the pick inside the horseshoe-shaped receptacle.

U.S. Pat. No. 1,263,740 features a pick for stringed instruments which is constructed with a small hole or aperture at the gripping end of the pick. A thin wire is inserted through the hole and then looped on both sides of the pick. The double loops provide resting places, or anchors, for the two most conveniently located fingers involved in gripping the pick for playing.

U.S. Pat. No. 2,776,592 describes a guitar pick attachment designed with a ring-like mechanism to fit over the forefinger. This helps prevent accidental dropping of the pick. The ring-like mechanism is connected to the pick by a “tongue” that is an integral part of the pick. The pick may be swiveled around its position on the ring-like mechanism to a non-playing position, which allows freedom of the fingers to pluck the instrument.

U.S. Pat. No. 3,699,838 consists of a guitar pick manufactured with an integral, continuous circular band extending from both sides of the pick. The band is designed with sufficient tension so as to securely hold a thumb or finger as that digit is inserted within the circular band in preparation for gripping the pick.

A relatively intricate pick design is disclosed in U.S. Pat. No. 4,270,433, which claims a plectrum ring. The ring element is designed to be worn about the middle finger of the musician's playing hand, with the plectrum being snapped into place by means of a stud and boss assembly on the surface of the ring element. The plectrum may have one or more boreholes drilled into it to allow a selection of multiple positions and angles for the plectrum to be attached to the ring element. Other variations of this basic mechanism are further disclosed.

U.S. Pat. No. 4,497,237 consists of a guitar pick with two curved metallic bands attached to the pick. The pick itself has two small pads, one glued to each side of the gripping half of the pick. There are grooves within the pads to allow the insertion of the two bands. The bands are relatively stiff but deformable to allow insertion of the musician's fingers and also to allow the pick to be swiveled out of playing range when the pick is not in use.

U.S. Pat. No. 5,837,913 features a plectrum which is attached to a flexible tongue device, which in turn is connected to a bendable, circular hand engaging member. The hand engaging member is designed to be variably fitted onto the base of the musician's middle finger. Thereafter, the flexible tongue stretches to allow the pick to be grasped by the musician's thumb and forefinger for playing the instrument.

An abandoned British patent application (publication #GB2347550) discloses a variety of plectrum devices, including one with a handle to be grasped in the user's first. At least one variety of the handle is manufactured with a tongue-like device which is integral to the handle and extends outward an appropriate distance so as to allow the attachment of a pick to the tongue.

Another development with respect to playing stringed instruments is a device referred to as the F-1™ “Ergonomic Guitar Pick.” This invention is described in U.S. Pat. No. 6,054,643 and is designed to be used as either a pick or a pick holder. It resembles an inverted clamshell, and features a pick of engineered material with a curved finger grip. One side of the device is a finger cradle, or saddle, to accommodate either the thumb or the index finger of the musician. The opposite side of the device is a flat planar area for ease of gripping with pressure exerted by the other fingers.

### BRIEF SUMMARY OF THE INVENTIVE CONCEPT

The inventive concept herein disclose re-designed plectrums, sometimes commonly referred to as guitar picks, suitable for various means of attachment to a grasping device while playing a stringed musical instrument. The disclosed plectrums feature an extended gripping surface, or “tab,” which allows a musician to more effectively hold the plectrum and to apply more forceful leverage when the plectrum strikes the strings of a musical instrument. A further advantage of the tab is that it provides a means for attaching a variety of grasping devices to the tabs. The various grasping devices presented in this inventive concept allow the musician more comfort, reliable gripping pressure, and a greater consciousness of ergonomic muscular movements for playing a musical instrument, particularly guitars.

### BRIEF DESCRIPTION OF THE VIEWS OF THE DRAWINGS

The objects, features, and advantages of the concept presented in this application are more readily understood when referring to the accompanying drawings. The drawings, totaling twenty figures, show the basic functioning of the inventive concept as it sequentially progresses through various other embodiments and methods. In the several figures, like reference numbers are used in each figure to correspond to the same component as may be depicted in other figures.

FIG. 1 depicts a common or standard plectrum, or “pick” which has been enhanced by the construction of an extended gripping end, referred to as a “tab.”

FIG. 2 presents a view of the enhanced plectrum in which the hook component of a hook-and-felt fastening mechanism has been adhesively attached to the tab of the plectrum.

FIG. 3 illustrates an enhanced plectrum with an aperture cut into the tab, (referred to as a “slotted plectrum”) said aperture allowing a means of attaching various grasping devices to the plectrum.

FIG. 4 depicts a full-length view of a straight-line grasping device (“SLGD”). As shown, each end of the SLGD is flared into a wedge shape with the felt component of a hook-and-felt fastening mechanism. Immediately above the wedge is a longer length of the hook component of the fastening mechanism.

FIG. 5 shows a variably-looped grasping device (“VLGD”). The VLGD is specifically designed to provide both a means of attaching the VLGD to the plectrum and an ergonomically efficient method of orienting and applying the plectrum to play a stringed musical instrument

FIG. 6 presents a view of the Double-Folding Grasping Device (“DFGD”). A portion of each end of this grasping device is constructed with the hook component of a hook-and-felt fastening mechanism, while the center portion comprises the felt component.

FIG. 6(a) illustrates one end of the Double-Folding Grasping Device in the process of being attached to a slotted plectrum with the opposite end of the DFGD clamped by a retaining mechanism.

FIG. 7 presents an adjustable retaining device used in conjunction with either the SLGD or the DFGD. The retaining device adjusts the length of either device so as to comfortably fit within the grasp of the playing hand of the musician.

FIG. 8 illustrates the ergonomic method of grasping the plectrum and the manner of holding the SLGD in the grasp of the instrument player's hand. Vectors representing efficient wrist and forearm orientation and movement are depicted.

FIG. 9 illustrates the VLGD as it is inserted into the slotted plectrum.

FIG. 10 shows the method of grasping the plectrum and arranging the VLGD about the fingers of the playing hand. Vectors depict the most ergonomic orientation and movements of the hand and wrist while using the VLGD.

FIG. 11 depicts an alternative embodiment of the DFGD, with the addition of a flexible medium connecting the two fastening ends of the device.

FIG. 12 presents a view of the alternative embodiment of the DFGD, showing the orientation of the hook and felt components of the fastening mechanism.

FIG. 13 is a plan view of a grasping device, referred to as a “pic tether,” an elastomeric strap.

FIG. 14 is an end view of the pic tether.

FIG. 15 presents a side view of the pic tether.

FIG. 16 is a view of a plectrum with a “gooseneck” tab.

FIG. 17 depicts the completely assembled gooseneck plectrum device with the pic tether looped onto an oblong fastening slot, and also attached to the plectrum.

FIG. 18 presents a top view of the wristband.

FIG. 19 shows a side view of the wrist band illustrating the gooseneck plectrum inserted into one of the two pic pockets.

FIG. 20 is a side view, oriented 90 degrees from the side view of FIG. 19.

Nomenclature For Invention Components

| 1. | Enhanced plectrum |
|---|---|
| 2. | Apex of plectrum |
| 3. | Tab |
| 4. | Hook component of |
| | fastening mechanism |
| 5. | Plectrum (modified) |
| 6. | Aperture |
| 7. | Plectrum (slotted) |
| 8. | Felt component for |
| | fastening |
| 9. | SLGD |
| 10. | Wedge |
| 11. | VLGD |
| 12. | DFGD |
| 13. | Retaining mechanism |
| 14. | not applicable |
| 15. | Flexible medium |
| 16. | Alternative embodiment, |
| | DFGD |
| 17.-19. | not applicable |
| 20. | Centerline between apex |
| | and aperture |
| 21. | Forearm static vector |
| 22. | Rotational arc of forearm |
| 23. | Rotational arc of wrist |
| | a) upward b) downward |
| 24. | Distal joint of index finger |
| 25. | Proximal joint, index finger |
| 26. | Inner wrist bone |
| 27. | Guitar string |
| 28. | Strumming axis |
| 29. | n/a |
| 30. | n/a |
| 31. | Retaining device spring |
| 32. | Retaining device spring |
| 33. | Inlet opening |
| 34. | Piston |
| 35. | Chamber |
| 36. | Outlet opening |
| 37. | n/a |
| 38. | n/a |
| 39. | n/a |
| 40. | Pic tether |
| 41. | Oblong fastening slot |
| 42. | Tab pocket |
| 43. | Tab holding slot |
| 44. | “T”-tab |
| 45. | Gooseneck plectrum |
| 46. | Gooseneck tab |
| 47. | Tab beak |
| 48. | Tab neck |
| 49. | Plectrum shoulder |
| 50. | Apex of gooseneck plectrum |
| 51. | Wristband outer surface |
| 52. | Wristband inner surface |
| 53. | Pic pocket |
| 54. | Pic pocket slot |
| 55. | Tether retaining slot |
| 56. | Wristband |

### DETAILED DESCRIPTION OF THE INVENTIVE CONCEPTS

### Plectrum Designs

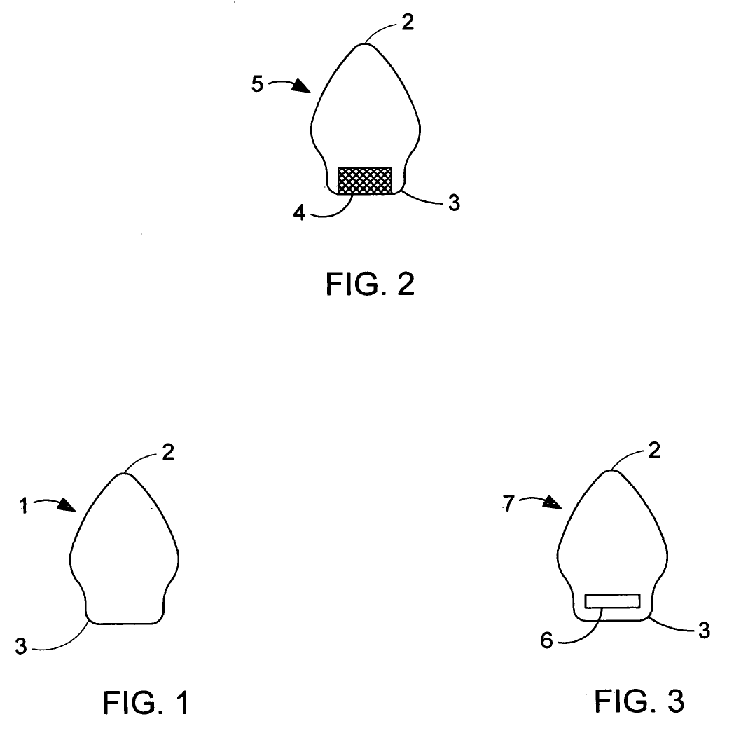

FIG. 1 presents an enhanced design of the traditional plectrum. As shown, the enhanced plectrum 1 resembles the standard contour of the vast majority of plectrums commonly used. The plectrum 1 is held by its flat surfaces and normally grasped between the musician's thumb and index finger. An elliptically-shaped apex 2 is the plectrum surface point, or “picking point” at which the plectrum 1 normally makes contact with the strings of the musical instrument. A person skilled in the art will observe that a novel difference appears in this enhanced version, wherein the plectrum 1 is fabricated with an extended, or protruding gripping surface, referred to in this inventive concept as a “tab” 3. The tab 3 serves (a) to increase the gripping surface of the plectrum 1, (b) to increase the leverage of the plectrum 1 as it strikes the strings of a musical instrument, and (c) as a means of attaching a plurality of hand-held grasping devices to different embodiments of the plectrum 1.

In FIG. 2, a useful embodiment of the enhanced plectrum 1 shows a modified plectrum 5, which is an enhanced plectrum further improved by the addition of the hook component 4 of a hook-and-felt fastening mechanism, which component may be adhesively attached to the tab 3 of the modified plectrum 5. This hook component 4 of a hook-and-felt fastening mechanism allows the attachment of a plectrum to the appropriate segment of a plurality of grasping devices, said devices so constructed with the corresponding felt component 8 of the hook-and-felt fastening mechanism.

In a different plectrum embodiment, FIG. 3 depicts a “slotted” plectrum 7, an enhanced plectrum constructed with an aperture 6. The aperture 6 serves as a means of attaching a variety of custom-made grasping devices to the slotted plectrum 7. By using custom-made grasping devices, said devices so designed with strap-like contours, one end of any of these several devices can be inserted into the aperture 6 and, by various means, secured to, or by, the playing hand of the musician.

In yet another embodiment, a plectrum having a tab similar to the neck of a goose (the “gooseneck plectrum”) is depicted in FIG. 16. The gooseneck tab design possesses the appreciable advantage of ease of attachment to its compatible grasping device, both of which will be fully discussed later in this application.

The primary objective of the various plectrum designs is to provide a means by which a stringed musical instrument (particularly, guitar) may be played with a plectrum that has enhanced and versatile gripping qualities. By utilizing the various grasping devices which are disclosed in the following paragraphs, a musician is aided in minimizing minimize muscle strain and other repetitive use injuries often associated with frequent playing a stringed musical instrument. The combined use of the enhanced plectrums and grasping devices will also help generate a more solid, accurate, and confident striking of the strings

### Grasping Devices

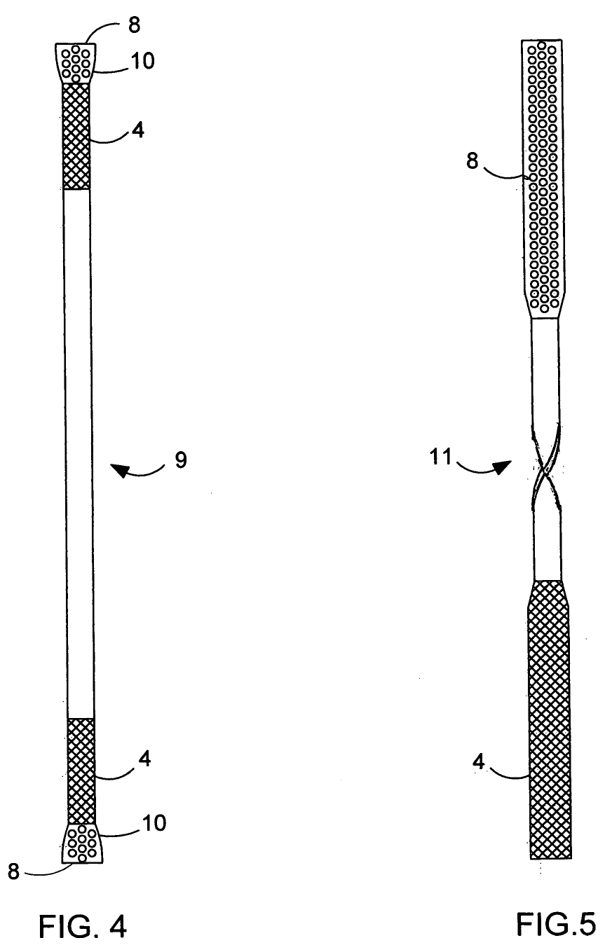

FIG. 4 illustrates the basic grasping device, referred to as the Straight-Line Grasping Device (SLGD) 9. This device is designed to be compatible with the modified plectrum 5 depicted in FIG. 2. The SLGD 9 has a contour similar to that of a miniature strap or belt and is symmetrically designed. At each end of the SLGD 9 is a flared section, or wedge 10. The dimensions and overall area of the wedge 10 correspond to the approximate dimensions and surface area of the adhesively-attached hook component 4 of the plectrum tab 3 shown in FIG. 2. Further, both sides of this flared section of the wedge 10 comprise the felt component 8 of a hook-and-felt fastening mechanism. Therefore, the wedge 10 can be easily fastened to the plectrum tab 3 by positioning either side of the wedge 10 onto the hook component 4 of the plectrum tab 3 and applying slight pressure so as to fasten the two components together.

The SLGD 9 is of sufficient length so as to fit comfortably in the grasp of a musician's strumming, or plucking hand, i.e., the hand that is predominantly used for striking the strings of the musical instrument. Immediately adjacent to the wedge 10 area of the SLGD 9 is a brief section comprising the hook component 4 of a hook-and-felt attaching mechanism. By this arrangement, the end of the SLGD 9 which is not attached to the tab 3 of the plectrum 5 may also be utilized to hold a spare, or a different weight plectrum, simply by inserting the unattached end through the spare plectrum aperture 6 and re-attaching to the hook component of the SLGD 9. Additionally, as will be shown later, the musician may attach a retaining device to the end of the SLGD 9 not currently in use for playing.

In referring to FIG. 5, the illustration depicts a device entitled a Variably-Looped Grasping Device (VLGD) 11. A full-length view of one side of the VLGD 11 is presented. Approximately one-third of one endmost section of the length of the VLGD 11 is comprised of the felt component 8 of a hook-and-felt fastening mechanism, while the opposite endmost section is comprised of the same length of the hook component 4 of the hook-and-felt fastening mechanism. Should the view be rotated on a vertical axis in a manner as to show the opposite side of the VLGD 11, the opposite side would appear exactly as in FIG. 5.

The VLGD 11 is constructed such that either end of the device may be inserted through the aperture 6 of the slotted plectrum (as shown in FIG. 3), looped around the musician's playing hand or fingers, and thereupon pressed against the opposite end with sufficient pressure to engage the fastening mechanism.

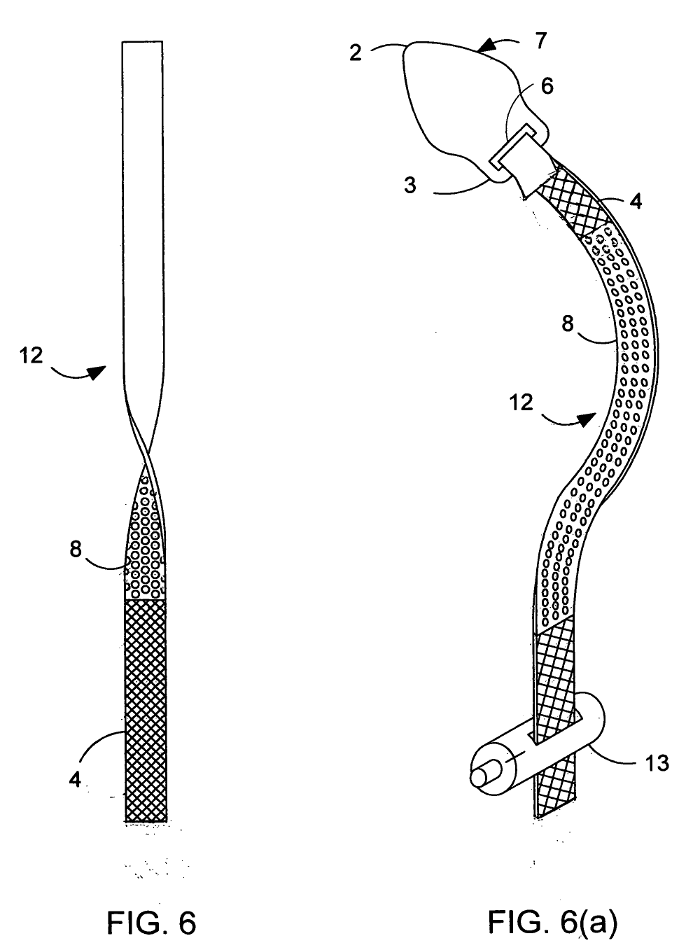

FIG. 6 depicts a grasping device entitled a Double-Folding Grasping Device (DFGD) 12. This device is comprised of the hook component 4 of a hook-and-felt fastening mechanism forming each end of the device, and the remaining center segment of the device comprised of the felt component 8 of the hook-and-felt fastening mechanism. The reverse side of the DFGD 12 is devoid of either the hook or the felt component of the hook and felt fastening mechanism.

FIG. 6(a) illustrates the operating mode of the DFGD 12, which is designed to function with the slotted plectrum 7 shown in FIG. 3. One end of the DFGD 12, comprised of the hook component 4 of a hook-and-felt mechanism, is inserted into the aperture 6 of the slotted plectrum 7 a sufficient distance so as to permit the inserted end to be folded back onto the section of felt component 8 of the DFGD 12. In this manner, the DFGD 12 is securely attached to the slotted plectrum 7.

The opposite end of the DFGD 12 may be inserted into a retaining mechanism 13 a sufficient distance so as to be folded back onto the felt component 8 of the DFGD 12, thus holding the retainer 13 at the end of the DFGD 12. The retaining mechanism 13 shown is a common version of a spring-loaded toggle clip used extensively in various types of clothing attire.

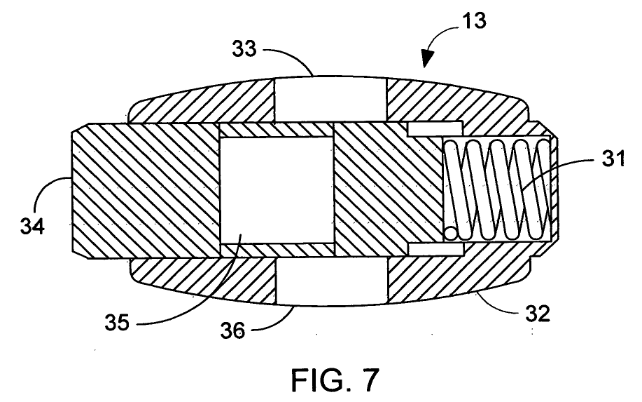

In viewing FIG. 7, the details of a typical retaining mechanism 13, which may be used in conjunction with the DFGD 12, are shown. In operation, the musician grasps the body 32 of the retaining mechanism 13, while simultaneously pushing the retaining mechanism's piston 34 from left to right against the resistance of a spring 31. The pushing force exerted causes a chamber 35 to slide into alignment with an inlet opening 33 and an outlet opening 36. One end of the DFGD 12 is then inserted through the inlet opening 33, the chamber 35, and the outlet opening 36, in sequence. The pressure on the piston 34 is then released, causing the DFGD 12 to be securely clamped between the interior of the body 32 and the outer wall of the piston 34.

The musician may further bend the inserted end of the DFGD 12 around the retaining mechanism 13 and attach the end to the felt component 8 of the DFGD. If it becomes necessary to adjust the length of the DFGD 12 in FIG. 6(a), the musician must push on the piston 34, thereby releasing the grip of the retaining mechanism 13, and permitting the DFGD 12 to slide freely through the chamber 35 in either direction.

By grasping the plectrum 7 in preparation for playing a stringed musical instrument, the musician should allow the length of the DFGD 12, while attached to the retainer 13, to hang freely within the grasp of the curled fingers of the strumming hand. The musician may then establish an effective and comfortable playing position using proper hand and wrist orientation. After making the necessary length-wise adjustment to the DFGD 12, the retaining mechanism 13 may, if desired, rest snugly against the outer portion of the little finger while playing.

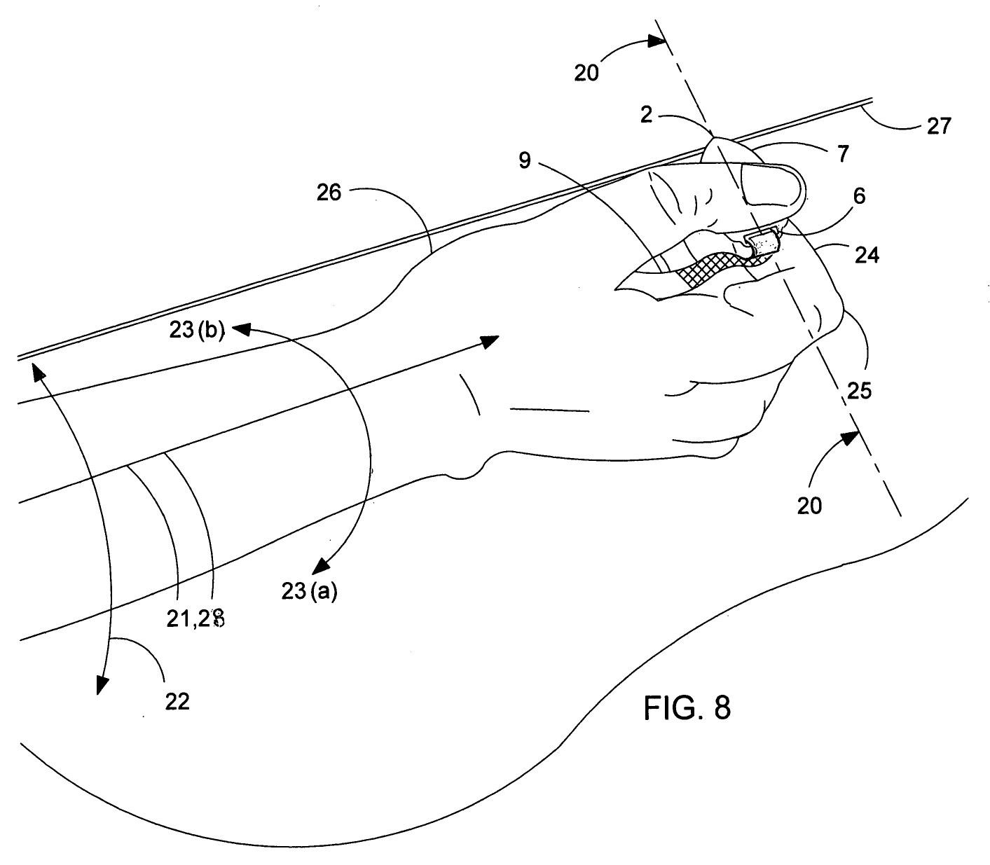

Next, we turn our attention to FIG. 8, depicting a musician's hand holding a slotted plectrum 7 and simultaneously allowing the hand to loosely grasp a Straight-Line Grasping Device (SLGD) 9. For simplicity's sake only one string 27 of a guitar is shown.

FIG. 8 demonstrates the preferred manner of grasping the plectrum 7 when utilizing the SLGD 9. The flat surfaces of the plectrum 7 are “sandwiched” between the thumbprint and the outside portion of the index finger, directly on top of the index finger's distal joint 24. The SLGD 9 can be observed suspended lightly within the curl of the musician's fingers. Ideally, when the plectrum 7 is held ergonomically correct, a centerline 20 drawn between the apex 2 of the plectrum 7 and the aperture 6 should overlay and parallel a line connecting the distal joint 24 and proximal joint 25 of the index finger. Thus oriented, the plectrum 7 can be brought into close proximity with the string 27 of the musical instrument and the plectrum 7 is easily directed to make forceful, or light, contact with any of the strings.

FIG. 8 further serves to illustrate the preferred method of manipulating the musician's hand, inner wrist bone 26, and forearm muscles 22, while playing a stringed musical instrument, such as guitar, banjo, mandolin, or other similarly designed instrument. For illustrative purposes only, the aperture 6 is made visible in FIG. 8. However, during actual instrument playing conditions, the aperture 6 may be covered by the inner edge of the thumb. In FIG. 8, a pointed straight line, referred to as the “forearm static vector” 21, represents an imaginary line between the aperture 6 of the plectrum 7, the inner wrist bone 26, and the elbow (which is out of view in this Figure). The same forearm static vector 21 also overlays another important vector concept in this invention, the “strumming axis” 28. If the forearm static vector 21 were extended toward the musician's hand, and if the aperture 6 of the plectrum 7 could be viewed while looking through the thumbnail, the aperture 6 would lie directly over the extended strumming axis 28.

To initiate the ergonomic striking of the string 27 for a single “pluck,” the musician must rotate the inner wrist bone 26 in the direction shown in FIG. 8 by the downward wrist rotational vector 23(b), which causes the firmly-held plectrum 7 to strike the string 27 with downward force (downstroke) and consequentially cause the string 27 to vibrate in the appropriate pitch. After the downward pluck of the string 27, the plectrum 7 is then in position to initiate an “upstroke” against the string 27. This is done by merely allowing the forearm muscle 22 to command a rotation of the inner wrist bone 26 in the direction shown by the upward wrist rotational vector 23(a), causing the plectrum 7 to contact the string 27 from underneath, again resulting in vibration of the string 27 at the appropriate musical pitch. It is important to maintain the inner wrist bone 26 and forearm 22 aligned with the strumming axis 28.

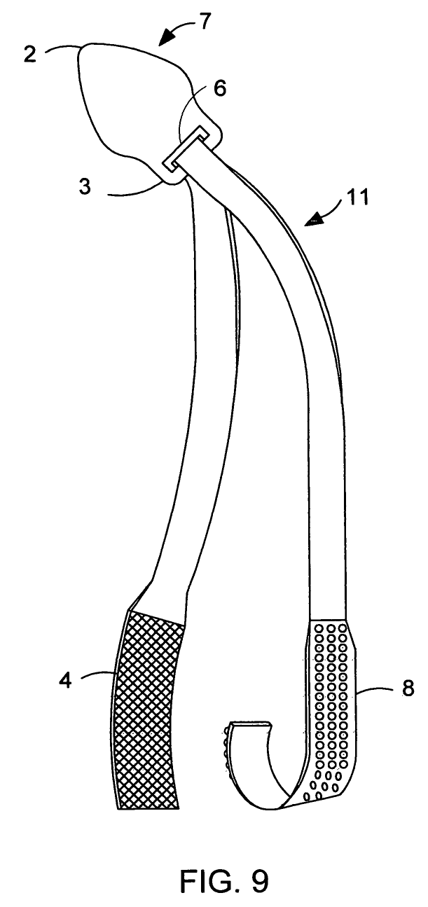

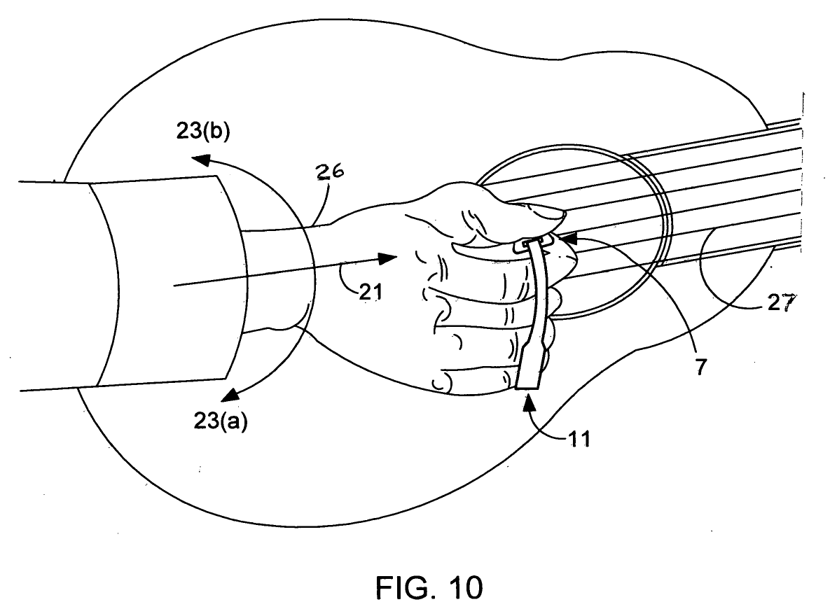

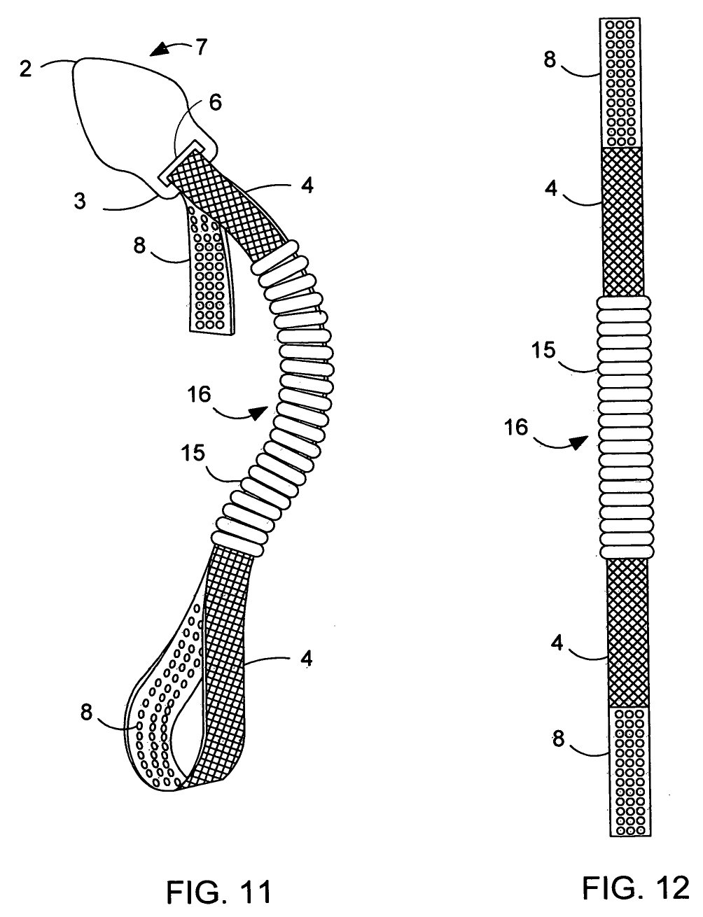

FIG. 9 illustrates the VLGD 11 after it has been inserted through the aperture 6 of the plectrum 7. Next, the musician inserts his playing hand in between the two “legs” of the VLGD 11 while holding the plectrum 7. Commonly, the VLGD 11 is loosely wrapped, in a comfortable fit, about the four fingers of the playing hand and then the VLGD 11 is fastened by attaching the hook component 4 to the felt component 8 of the VLGD 11. FIG. 10 then reveals the preferred means of grasping the plectrum 7 and the VLGD 11 to facilitate playing the instrument.

In FIG. 10, the rotational vectors 23(a) and 23(b) are again depicted for the purposes of demonstrating the most ergonomic method of positioning the plectrum 7 to contact the strings 27 of the instrument. By virtue of grasping the VLGD 11 while simultaneously holding the plectrum 7, the musician consciously positions his/her inner wrist bone 26 and forearm to maintain the proper orientation with respect to the forearm static vector 21. The forearm muscles are then recruited to provide rotation of the wrist 26, and the corresponding plectrum 7 movement causes contact with the strings 27 of the instrument.

For continuous vibrato-type striking movements against the string 27, the musician need only recruit the forearm muscle 22 to rotate the inner wrist bone 26 back and forth as rapidly as desired, alternating the inner wrist bone 26 rotation in the directions shown by the rotational vectors, 23(a) and 23(b). The musician's elbow may need to change its angle slightly relative to the upper arm (humerus bone) in order to maintain the orientation of the static forearm static vector 21. The muscle movements herein described serve to minimize muscular fatigue, Repetitive Strain Injury (RSI), carpal tunnel syndrome, and varied forms of “tennis elbow.” These ailments are often suffered by guitarists who practice and/or play engagements regularly and for long sessions, without conscious effort to efficiently coordinate their arm muscle groupings.

For general consumer marketing, most plectrums or picks are fabricated of a relatively inexpensive, thin plastic which is designed to bend, but may also break if sufficient force is applied to the plectrum. The tension of the VLGD 11 or the SLGD 9, as either device is routinely pulled against the aperture 6 of the slotted plectrum 7, may also place additional vulnerable stress points on the tab 3 and cause occasional breakage. In the event of breakage of a plectrum 7, the musician may choose to continue playing the remainder of the musical passage by holding the plectrum 7 without the assistance of the grasping device. When time permits, the musician need only undo the fastening mechanism of the grasping device, insert one end of the device into the aperture 6 of a spare plectrum 7, and re-fasten.

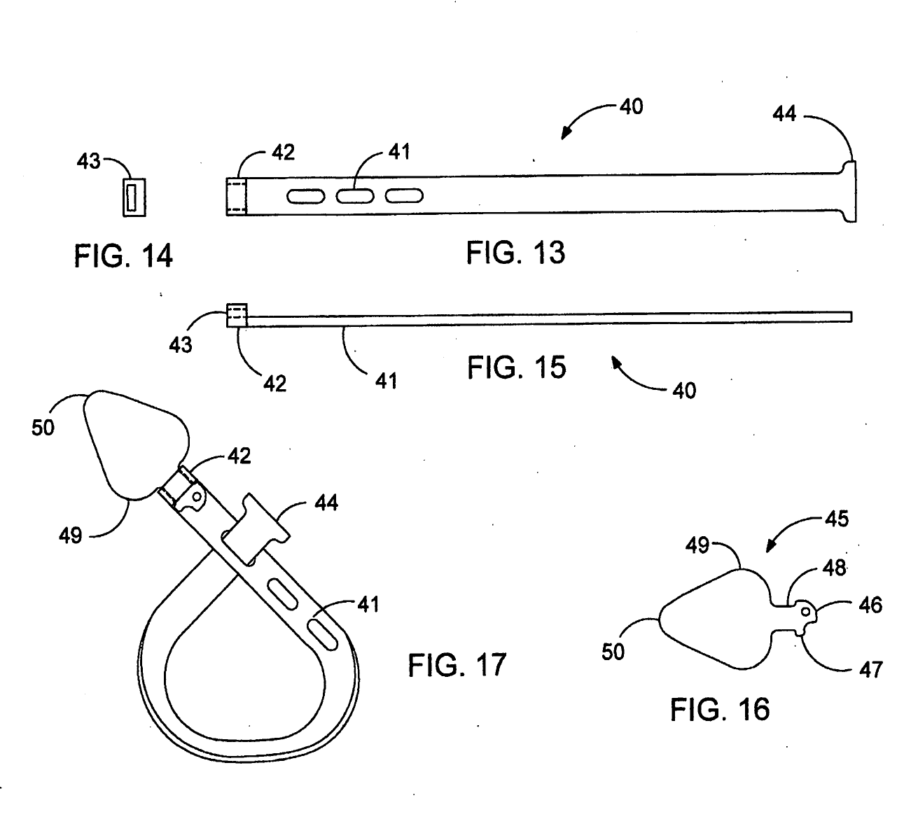

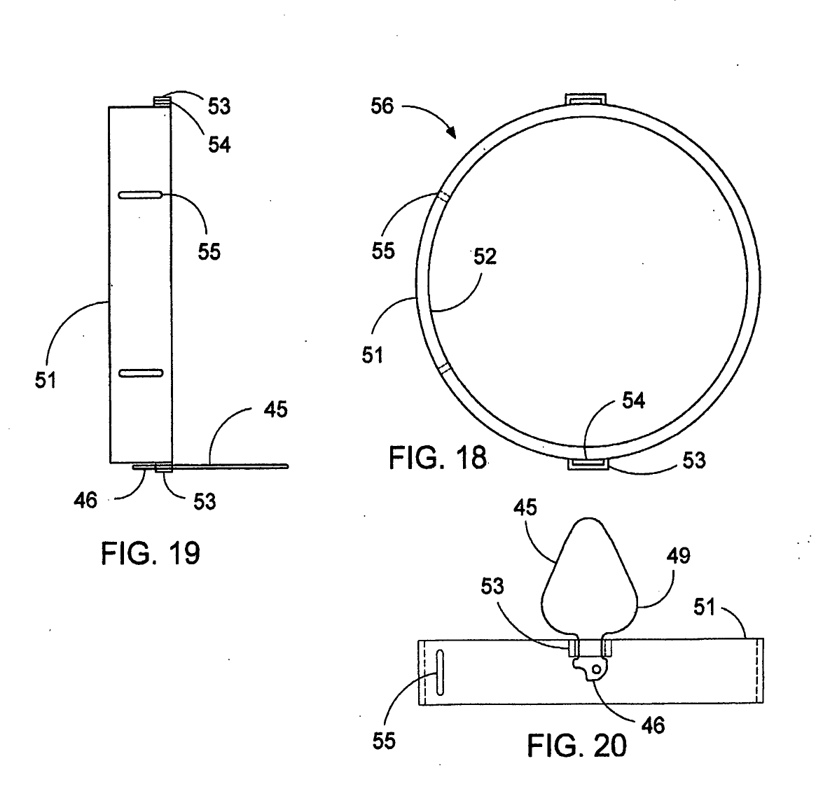

An alternative embodiment of the VLGD is depicted in FIGS. 13 through 17. FIGS. 13, 14, and 15 present a grasping device in the form of an elastomeric pic tether 40 having an attaching mechanism consisting of a box-shaped tab pocket 42 with a tight fitting tab holding slot 43 integral to one end of the pic tether 40. Further, FIG. 16 presents a specially configured plectrum, referred to as a “gooseneck” plectrum 45, having a gooseneck tab 46, a tab beak 47, and a neck tab 48. The special design of the gooseneck plectrum 45 allows the gooseneck tab 46 to securely fit into the tab holding slot 43 of the pic tether 40. Upon insertion of the gooseneck plectrum 45 into the tab pocket 42, the tab beak 47 protrudes into the resilient innards of the tab holding slot 43, thereby effectively retaining the gooseneck plectrum 45 within the tab pocket 42.

A musician may effectively grasp the pic tether 40 along its length, while playing a stringed instrument, which serves to enhance ergonometric movements of his/her playing wrist and forearm. Or, alternatively a musician may bend the “T”-tab 44 at the opposite end of the pic tether 40 toward one of the oblong fastening slots 41, insert the “T”-tab into said slot 41, (as shown in FIG. 17) and two, three, or four non-playing fingers may be encompassed within the circumference of the loop formed thereby.

For the sake of convenience, an elastomeric wristband 56 having a plurality of tether retaining slots 55 may be utilized for a variety of purposes, including (1) retaining the “T”-tab of the pic tether 40 while the musician is playing an instrument with a gooseneck plectrum 46 attached to the tab pocket 42 at the opposite end of the pic tether 40, (2) storing an extra gooseneck plectrum 45 in one of its pic pockets 53, (as shown in FIG. 20), or (3) storing the pic tether 40 between playing engagements.

It must be realized that the embodiments presented in this inventive concept are not dependent solely upon a particular mechanism as the means of efficient or effective fastening of any of the disclosed plectrums to any grasping device, or as the means of re-attaching any grasping device to itself. Fastening means such as zippers, pins, suction devices, track-and-groove fasteners, miniature snaps, magnets, or other mechanisms may function as well, if not better. In other words, a variety of fastening means are readily capable of providing the functionality encompassed by this inventive concept and this variety of fastening mechanisms is fully envisioned as probable alternative embodiments of the concept. Furthermore, any grasping device may feature an expandable or flexible medium in conjunction with the means of attachment so designed as part of the grasping device.

What is claimed is:

1. A plectrum device suitable for playing a stringed musical instrument, comprising a flat, thin surface, formed from any of a variety of materials, in the approximate shape of an isosceles triangle with gently rounded base angles, an elliptically-shaped planar picking point at its apex, the thickness of the plectrum varying in the range of 0.50 mm to 2.0 mm, and having an extended gripping end at the midpoint of the base of the triangular shape, said gripping end referred to as a “tab.”

2. A device as in claim 1, further comprising
a means of attaching to the plectrum device, any one of a plurality of grasping devices, said grasping devices constructed from any single material, or combination of suitable materials, and said grasping device containing an integral attachment means compatible with said plectrum device.

3. A plectrum device suitable for playing a stringed musical instrument, comprising a flat, thin surface, formed from any of a variety of materials, in the approximate shape of an isosceles triangle with gently rounded base angles, an elliptically-shaped planar picking point at its apex, the thickness of the device varying in the range of 0.50 mm to 2.0 mm, and having an extended gripping end at its base, said gripping end referred to as a “tab,” and said tab containing the hook component of a hook-and-felt fastening mechanism.

4. A device as in claim 3, further comprising
a means of attaching to the plectrum, any one of a plurality of grasping devices, said grasping devices constructed with at least one end of the device composed of the felt component of a hook-and-felt fastening mechanism.

5. A device as in claim 3, further comprising a means of attaching to the plectrum a Straight-Line Grasping Device (SLGD), said means comprising
a) a strap with each end of the strap flared slightly into wedge shapes, each wedge shape with dimensions approximately the same dimensions as the tab of said plectrum; and
b) each wedge shape comprising the felt component of a hook-and-felt fastening mechanism; and
c) placing, in the corresponding orientation, either of said wedge shapes onto the tab of the plectrum, and applying slight pressure so as to fasten the wedge of the SLGD onto the tab of the plectrum.

6. A plectrum device suitable for playing a stringed musical instrument, comprising a flat, thin surface, formed from any of a variety of materials, in the approximate shape of an isosceles triangle with gently rounded base angles, an elliptically-shaped planar picking point at its apex, the thickness of the device varying in the range of 0.50 mm to 2.0 mm, and having an extended gripping end at the midpoint of the base of the triangular shape, said gripping end referred to as a “tab,” and said tab having an opening, referred to as an “aperture,” of suitable size and dimensions cut into the tab.

7. A device as in claim 6, further comprising
a) a means of attaching to the plectrum device, by insertion through the aperture of the plectrum, any one of a plurality of grasping devices, said grasping devices constructed from any single material, or combination of suitable materials, and said grasping device further constructed with an integral means of re-attachment to itself.

8. A device as in claim 6, further consisting of a means of attaching to the plectrum, a grasping device suitable for looping about the playing fingers of a musician, said means comprising
a) a strap, referred to as a “VLGD,” wherein both sides of one endmost one-third of the length of the VLGD consist of the hook component of a hook-and-felt fastening mechanism; and
b) both sides of the opposite endmost one-third of the length of the VLGD consist of the felt component of a hook-and-felt fastening mechanism; and
c) the insertion of one end of the VLGD through the aperture of the tab; and
d) the formation and adjustment of the circumference of a loop formed by the
VLGD so as to comfortably fit around the fingers of the playing hand of a stringed instrument player; and
e) the juxtaposition of the opposite ends of the VLGD onto each other; and
f) the application of slight pressure to the ends of the VLGD, thereby fastening the VLGD onto itself.

9. A device as in claim 6, further comprising of a means of attaching to the plectrum a grasping device, which grasping device is capable of supporting a retaining mechanism at either end of the grasping device, said means comprising
a) a strap, referred to as a Double-Folding Grasping Device, or “DFGD,” wherein said DFGD is constructed such that each of the endmost one-quarter lengths of the DFGD consists of the hook component of a hook-and-felt fastening mechanism, and the center section of the DFGD, consisting of one-half of the total length of the DFGD, consists of the felt component of a hook-and-felt fastening mechanism; and
b) inserting one end of said DFGD through the aperture of the plectrum; and
c) folding back the inserted end of the DFGD so as to bring said end into contact with a portion of the felt component of the hook-and-felt fastening mechanism; and
d) applying slight pressure to the inserted end of the DFGD so as to fasten the
DFGD onto itself; and
e) inserting the opposite end of said DFGD into the retainer mechanism.

10. A method for the ergonomic playing of a stringed musical instrument when using a pick or plectrum device, comprising the steps of:
a) utilizing a plectrum device as in claim 3; and
b) fastening to said plectrum a grasping device referred to as a Straight Line Grasping Device (SLGD); and
c) grasping said plectrum between the thumb and the index finger of the strumming or playing hand; and
d) allowing the SLGD to hang freely in a vertical orientation by rotating the wrist of the strumming hand into a playing position wherein the forearm is oriented approximately parallel to the strings of the musical instrument;
e) grasping the SLGD lightly, with the remaining fingers of the strumming hand;
f) orienting the strumming hand such that, while loosely grasping the SLGD, the outside edge of the thumbnail, the web of the thumb, the inside bone of the wrist, and the center of the elbow are oriented in a straight line, said line being referred to as the “forearm static vector;”
g) holding and/or resting the stringed instrument by shoulder strap or other means such that the forearm static vector is generally parallel to, and in the same direction as, the layout of the strings on the instrument;
h) rotating the wrist in a circular motion about the forearm static vector such as to cause the plectrum to strike the desired string(s) of the musical instrument while firmly holding the plectrum; and
i) maintaining a torque-like action of the forearm muscles of the strumming hand to power and control the rotation of the wrist about the forearm static vector, therefore causing the wrist to rotate and consequently control the plectrum's dynamics at any desired speed, intensity, frequency, and angle of rotation.

11. A method for the ergonomic playing of a stringed musical instrument when using a pick or plectrum device, comprising the steps of:
a) utilizing a plectrum device as in claim 6; and
b) fastening to said plectrum a grasping device referred to as a Straight Line Grasping Device (SLGD); and
c) fastening to said plectrum a grasping device referred to as a Variably-Looped
Grasping Device (VLGD); and
d) detaching the two ends of the VLGD and allowing approximately half of its length to vertically hang along the knuckles of the strumming, or playing hand;
e) grasping the plectrum between the thumb and the index finger of the strumming or playing hand;
f) grasping the two detached ends of said VLGD and juxtaposing one on top of the other so as to form a loop which comfortably encloses the remaining fingers of the playing hand;
g) grasping the plectrum proximate the tab and orienting the playing hand such that, while loosely grasping the VLGD, the outside edge of the thumbnail, the web of the thumb, the inside bone of the wrist, and the center of the elbow are oriented in a straight line, said line being referred to as the “forearm static vector;”
h) holding and/or resting the musical instrument by means of a shoulder strap or other supporting means such that the forearm static vector is generally parallel to, and aligned with, the layout of the strings of the instrument;
i) when required to play the instrument, rotating the wrist in a circular motion clockwise and/or counter-clockwise about the forearm static vector such as to cause the plectrum to strike the desired string(s) of the musical instrument while firmly holding the plectrum; and
j) maintaining a torque-like action of the forearm muscles of the strumming hand to power and control the rotation of the wrist about the forearm static vector, therefore causing the wrist to rotate and consequently control the plectrum's dynamics at any desired speed, intensity, frequency, and angle of rotation.

12. A plectrum device suitable for playing a stringed musical instrument, comprising a flat, thin surface, formed from any of a variety of materials, said plectrum device in the approximate shape of an isosceles triangle with gently rounded base angles, an elliptically-shaped planar picking point at its apex, and having an extended gripping end extending from the midpoint of the base of the triangle, said gripping end referred to as a “gooseneck tab,” and said gooseneck tab having a tab neck and a hook-shaped tab beak, the thickness of the plectrum device varying in the range of 0.50 mm to 2.0 mm.

13. A plectrum device as in claim 12, further comprising a detachable pic tether, said pic tether comprising
a) an elongated linear elastomeric strap having a first end and a second end;
b) said first end comprising a flared, T-shape;
c) said second end having an integral rectangular-shaped box, said box containing an open through-slot, wherein said through-slot has inner dimensions approximately commensurate with the outer dimensions of said gooseneck tab; and
d) a plurality of oblong holes said holes oriented lengthwise along the center of said elastomeric strap proximate the second end of said elastomeric strap, and each of said holes constructed with dimensions sufficient to stretchingly accommodate insertion of the T-shape of the first end of said linear strap.

14. A plectrum device as in claim 13, further comprising an elastomeric wristband device suitable for wearing on the wrist of a stringed musical instrument player, said wristband device further comprising:
a) a plurality of oblong holes, each of said oblong holes of sufficient dimensions to bendingly accommodate the insertion of the T-shape of the first end of said elastomeric strap; and
b) a plurality of integral pic pockets constructed of sufficient dimensions so as to stretchingly accommodate the insertion of the gooseneck tab of said plectrum device.

15. A method for the ergonomic playing of a stringed musical instrument when using a pick or plectrum device, comprising the steps of:
a) utilizing a plectrum device as in claim 13; and
b) inserting the “T”-tab end of said pic tether into any one of the oblong fastening slots, thereby forming a looped shape;
c) grasping the plectrum proximate the gooseneck tab and orienting the playing hand such that a comfortable number of fingers of the playing hand are inserted into the looped shape;
d) loosely grasping the pic tether such that the outside edge of the thumbnail, the web of the thumb, the inside bone of the wrist, and the center of the elbow are oriented in a straight line, said line forming a “forearm static vector;”
e) holding and/or resting the musical instrument by means of a shoulder strap or other supporting means such that the forearm static vector is generally parallel to, and aligned with, the layout of the strings of the instrument;
f) rotating the wrist of the playing hand in a circular motion clockwise and/or counter-clockwise about the forearm static vector such as to cause the plectrum to strike the desired string(s) of the musical instrument while firmly holding the gooseneck plectrum; and
g) maintaining a torque-like action of the forearm muscles of the strumming hand to power and control the rotation of the wrist about the forearm static vector.
